(19) United States
(12) Patent Application Publication
(10) Pub. No.: US 2003/0037053 A1
(43) Pub. Date: Feb. 20, 2003

(54) Method and apparatus for automatically updating stock and mutual fund grammars in speech recognition systems

(76) Inventors: Zhong-Hua Wang, White Plains, NY (US); Martin Franz, Yorktown Heights, NY (US); David Lubensky, Danbury, CT (US); Salim E. Roukos, Scarsdale, NY (US)

Correspondence Address: Frank Chau, F. CHAU & ASSOCIATES, LLP, Suite 501, 1900 Hempstead Turnpike, East Meadow, NY, 11554, US

(21) Appl. No.: 09/925,596

(22) Filed: Aug. 9, 2001

(51) Int. Cl. G06F 7/00

(52) U.S. Cl. 707/100

(57) ABSTRACT

A method for automatically updating stock and mutual fund grammars in a speech recognition system includes the step of automatically updating, on a pre-specified basis, a database having a plurality of entries. Each entry respectively corresponds to a publicly traded stock or a publicly traded fund, and respectively includes at least one name of the publicly traded stock or publicly traded fund, a weight for the at least one name, and baseforms of the at least one name. A grammar file for names in the database is automatically updated. The grammar file includes the names and weights for the names. Preferably, the database and grammar file are updated on a daily basis.

### BACKGROUND OF THE INVENTION

1. Technical Field

The present invention relates generally to speech recognition systems and, in particular, to a method and apparatus for automatically updating stock and mutual fund grammars in speech recognition systems.

2. Description of Related Art

Speech recognition technology is becoming more and more widely used in financial applications, such as in stock and mutual fund trading or information inquiry. In these applications, a good grammar on the stock and mutual fund names is vital to the performance of the speech recognition system. In the past, such grammars were manually generated, which required several months of difficult work due to the complexity of the task. The manual generation of such grammars is complex for a variety of reasons, some of which will now be described. One reason the manual generation of grammars for financial applications is complex is that most stock names published at web sites contain abbreviated words and are, thus, incomplete. Another reason the manual generation of grammars for financial applications is complex is that the “nick names” of most companies are not readily available. Yet another reason the manual generation of grammars for financial applications is complex is that some statistic parameters must be adjusted to achieve an acceptable degree of performance from the speech recognition system. Finally, another reason the manual generation of grammars for financial applications is complex is that some words are pronounced differently depending on the speaker.

Given that there are tens of thousands of stock and mutual fund names in the market and that significant numbers of companies are coming into and going out of the market on a daily basis, building an efficient and up-to-date stock and mutual fund grammar by hand is not only expensive, but it is also not feasible. Therefore, there is a need for a method and apparatus that automatically generates grammars of adequate quality for financial applications in a speech recognition system.

### SUMMARY OF THE INVENTION

The problems stated above, as well as other related problems of the prior art, are solved by the present invention, a method and apparatus for automatically updating stock and mutual fund grammars in speech recognition systems.

According to an aspect of the present invention, there is provided a method for automatically updating stock and mutual fund grammars in a speech recognition system. The method comprises the step of automatically updating, on a pre-specified basis, a database having a plurality of entries. Each entry respectively corresponds to a publicly traded stock or a publicly traded fund, and respectively comprises at least one name of the publicly traded stock or publicly traded fund, a weight for the at least one name, and baseforms of the at least one name. A grammar file for names in the database is automatically updated. The grammar file includes the names and weights for the names.

According to another aspect of the present invention, the updating step comprises the steps of automatically identifying, from web sites, stocks and funds that are no longer listed on a market, and automatically removing from the database any of the plurality of entries corresponding to the identified stocks and funds.

According to yet another aspect of the present invention, the updating step comprises the steps of automatically identifying, from web sites, newly listed stocks and newly listed funds, if any, and automatically creating an entry in the database for each of the newly listed stocks and the newly listed funds.

According to still another aspect of the invention, the updating step comprises the steps of identifying the transaction volumes of any stocks and funds for which an entry exists in the database, quantizing the transaction volumes into a plurality of bands, and assigning a corresponding weight to each of the plurality of bands.

According to still yet another aspect of the invention, the method further comprises the step of automatically combining short words in the database to form combined words. A short word is a stock name or a fund name that has less than a predefined number of phonemes. The baseforms for the combined words are automatically generating. The grammar file is updated to include the combined words.

According to a further aspect of the invention, the step of updating the database comprises the step of automatically adapting the weights for the names in the database, based upon a transaction volume over a predetermined period of time.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating an apparatus 100 for automatically updating, on a pre-specified basis, stock and mutual fund grammars in a speech recognition system, according to an illustrative embodiment of the present invention; and

FIG. 2 is a flow diagram illustrating a method for automatically updating, on a pre-specified basis, stock and mutual fund grammars in a speech recognition system, according to an illustrative embodiment of the present invention.

### DETAILED DESCRIPTION OF PREFERRED EMBODIMENTS

It is to be understood that the present invention may be implemented in various forms of hardware, software, firmware, special purpose processors, or a combination thereof. Preferably, the present invention is implemented as a combination of both hardware and software, the software being an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device.

It is to be further understood that, because some of the constituent system components depicted in the accompanying Figures may be implemented in software, the actual connections between the system components may differ depending upon the manner in which the present invention is programmed. Given the teachings herein, one of ordinary skill in the related art will be able to contemplate these and similar implementations or configurations of the present invention.

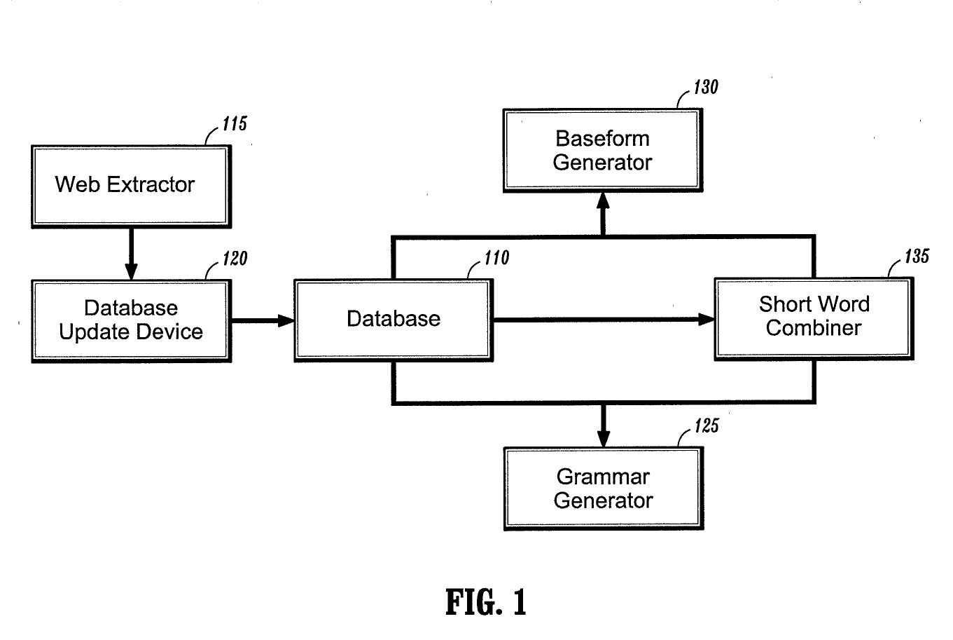

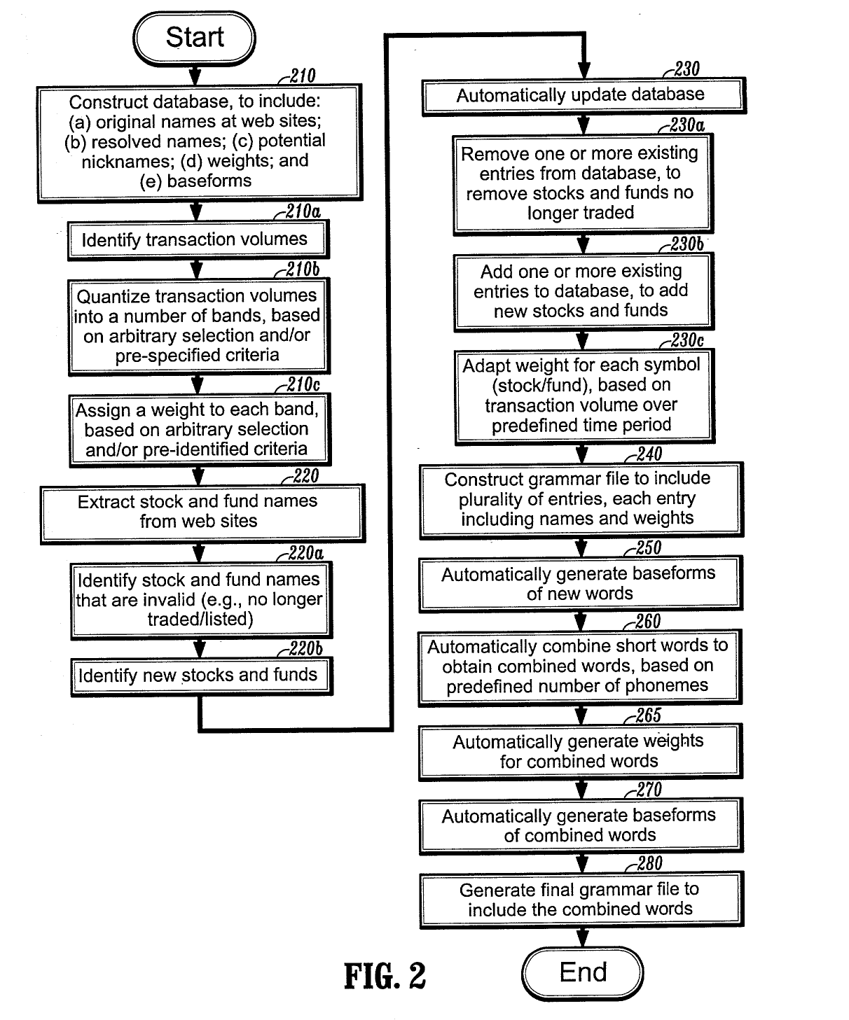

FIG. 1 is a block diagram illustrating an apparatus 100 for automatically updating, on a pre-specified basis, stock and mutual fund grammars in a speech recognition system, according to an illustrative embodiment of the present invention. The apparatus 100 includes a database or data structure 110 (hereinafter “database”), a web extractor 115, a database update device 120, a grammar generator 125, a baseform generator 130, and a short word combiner 135. While the present invention is described with respect to stocks and mutual funds, it is to be appreciated that the present invention may be applied to any type of financial commodity which is traded on any given financial market. Further, while the stock and mutual fund grammars are described herein as being updated “on a pre-specified basis”, it is preferable that such updating occur on a daily basis. Moreover, while the web extractor 115 is described with respect the web, it is to be appreciated that the functions of the web extractor 115 may performed with respect to any data source or network from which information can be extracted for use by the present invention. The operation of the elements of apparatus 100 will now be described with respect to FIG. 2.

FIG. 2 is a flow diagram illustrating a method for automatically updating, on a pre-specified basis, stock and mutual fund grammars in a speech recognition system, according to an illustrative embodiment of the present invention.

A database 110 is constructed (step 210), which includes the following information for each stock and mutual fund symbol: (a) the original name appearing at the web sites; (b) the resolved name which is the name of the fund after resolving word abbreviations, removing name ambiguities, and so forth; (c) potential nicknames; (d) weights for the symbols; and (e) all possible baseforms for each word. It is to be appreciated that while the database 110 is described to include the preceding specified information, other information may be used in addition to, or in substitution of, the above specified information or a portion(s) thereof. Given the teachings of the present invention provided herein, one of ordinary skill in the related art will readily contemplate other information that can be included in database 110 as well as which of the above specified information can be substituted or removed altogether, if so desired, all the while maintaining the spirit and scope of the present invention.

The rationale for including the above items in the database 110 will now be given. The fund names that appear at a web site generally include abbreviations. For example, a fund name appearing at a web site may be “CT HOLDINGS, INC.”, where “CT” is an abbreviated form of the word “court”, which should be resolved. A company may own several different stock symbols which might be represented by the same name. For example, the symbols “T”, “LMGA”, “LMGB”, and “AWE”, are all represented by “A T & T CORP.”, while in fact they represent the following different fund names: “A T & T Crop”, “A T & T Liberty Media Corp.”, “A T & T Corp. Class B”, “A T & T Wireless Group”, respectively. These different fund names should also be resolved. At the web site of a particular company, generally, only the official name of that company is specified, such as “INTERNATIONAL BUSINESS MACHINES CORP.”. However, in real life, people are apt to use nicknames, such as “IBM”. Thus, it is preferable that all possible nicknames of a company are added into the stock grammar. In speaker-independent speaker recognition systems, some words have different pronunciations depending on the speaker. Therefore, it is preferable to list all possible baseforms for each word in the vocabulary. This is achieved by listening to numerous live audio data of stock and mutual fund names. In real life, not all fund names are used with the same probability. Assigning different probabilities to different stock names based on frequency of use could enhance the performance of the speech recognition system.

The initial weight for each fund is determined according to the following method, represented by steps 110a-c in FIG. 2. The transaction volumes of all stocks and mutual funds in the database are identified (step 111a) and quantized into several different bands (also referred to herein as subsets) (step 110b). Each of the bands is assigned with a value of weight (step 110c). The number of bands to use may be determined arbitrarily and optionally modified based on experimental results, or may be based on pre-specified criteria such as, for example, the transaction volume. It is to be appreciated that the preceding pre-specified criteria is merely illustrative and, thus, other criteria may be used. The value assigned to each band may also be based on pre-identified criteria or may be arbitrarily selected and then modified based on experimental results. The pre-specified criteria for assigning a value of weight to each band may include, for example the transaction volume. It is to be appreciated that while the determination of the number of bands and the values of the weights have been described with respect to the transaction volume, other information may be used in conjunction with or in place of the transaction volume. Given the teachings of the present invention provided herein, one of ordinary skill in the related art will contemplate these and various other criteria for determining how many bands to use, as well as the values assigned to each band, while maintaining the spirit and scope of the present invention.

According to one illustrative embodiment of the present invention, steps 110b-c above are implemented such that the weight increases by a factor of two with an increase in the band number. However, in such a case, there must be some restriction on the band number N such that log(N) will not exceed the value of the dynamic score range of the searching process during speech recognition. Otherwise, the stock symbols in the band with the lowest weight will have no chance to be recognized, since they may be pruned out of the search space.

According to the preceding illustrative embodiment regarding steps 110b-c, the symbols are classified into two subsets. The symbols whose transaction volume is larger than the average transaction volume for all of the symbols in the database are assigned to subset 1; the remaining symbols are assigned to subset 2. All symbols in subset 1 are assigned with the weight value of 1.

The symbols in subset 2 are classified into two subsets. All symbols whose transaction volume is larger than the average transaction volume of the symbols in subset 2 are assigned to the subset 21; the remaining symbols in subset 2 are assigned to subset 22. All the symbols in subset 21 are assigned with the weight value of 0.5.

Similar to the preceding step, all symbols in subset 22 are classified into two subsets 221 and 222. All symbols in the subset 221 are assigned with the weight value of 0.25.

All symbols in subset 222 are classified into two subsets 2221 and 2222, and so forth, until 14 subsets are obtained, with the weight of the 1st subset to be 1, the second subset to be 0.5, the third subset to be 0.25, . . . , the 14th set to be 1/(2**13)=1/8192=0.000122. As noted above, this is but one illustrative implementation for determining the number of bands and the values of weights and, thus, other methodologies for accomplishing the same may be employed while maintaining the spirit and scope of the present invention.

It is to be appreciated that the construction of the database at step 110 may be performed using, at the least, the database update device 120 and the web extractor 115. The web extractor 115 could initially extract the stock and mutual fund names from web sites (as well as any nicknames, transaction volumes, and so forth), and the database update device 120 could resolve the extracted names, calculate the initial weights, and so forth. Of course, other arrangements are possible, including receiving and using a database which has already been constructed. Such a pre-constructed database could have an expiration date associated therewith, given the potential volume of changes that could occur in such a database over a very short period of time (e.g., new stocks and funds being included in the market and other stocks and funds being removed/delisted from the market).

Stock names and mutual fund names, as well as information corresponding thereto (e.g., nick names, transaction volumes, and so forth), are extracted from a set of stock exchange web sites (step 220), by the web extractor 115. Step 220 includes the step of identifying any stock names and mutual fund names that are no longer valid (i.e., the stocks and mutual funds that are no longer in the market (no longer traded/listed)) (step 220a), as well as new (e.g., newly listed) stocks and mutual funds (step 220b). In the illustrative embodiment of the present invention, the following seven stock exchange web sites are used: American Exchange; Canadian Dealer's Network Exchange; Montreal Stock Exchange; NASDAQ; New York Stock Exchange; OTC Bulletin Board; and Toronto Stock Exchange. Of course, other stock exchanges can be used, while maintaining the spirit and scope of the present invention.

The database 110 is automatically updated (step 230) by the database update device 120, based upon a result of step 220. Step 230 may include deleting one or more existing entries (step 230a) and/or creating one or more new entries (step 230b). For, example at step 230, entries corresponding to stocks and/or mutual funds that are no longer traded are removed from the database 110 (step 230a) and entries corresponding to new stocks and funds are added to the database (step 230b). Moreover, step 230 includes the step of adapting the weight for each stock symbol based on the transaction volume of the corresponding stock or fund over a predefined time period (e.g., last two weeks) (step 230c). Such adaptation is performed by the database update device 120. At step 230, it is preferable that a user manually check the new fund names, and appropriate nicknames, if possible.

A grammar file is automatically constructed from the database (step 240), by the grammar generator 125. The grammar file includes a plurality of entries, with each entry corresponding to a stock or mutual fund. In particular, each entry includes, for a given symbol representing a stock or mutual fund, a weight for the symbol and different names for the stock or mutual fund with optional words.

An example of two entries in the grammar file is as follows:

+0.010129856039 AMERICAN ANNUITY GROUP CAPITAL TRUST: NYSE_{—AAGPRT}

+0.270129494365 AAMES FINANCIAL CORP: NYSE_AAM

It is to be appreciated that the above configuration of the grammar file is for illustrative purposes and, thus, other configurations of the grammar file may be employed, while maintaining the spirit and scope of the present invention.

Baseforms of the new words are automatically generated from the grammar file (step 250), by the baseform generator 130. Preferably, the baseforms generated by the baseform generator 130 at step 250 are manually checked by a user. In the context of step 250, the phrase “new words” refers to those words for which baseforms have not yet been created. An example of a baseform file is as follows:

| | |
|---|---|
| AAMES | AA M Z |
| AMERICAN | AX M EH R IX K AX N |
| ANNUITY | AX N Y UW IX T IY |
| CORP | K AO R P AXR EY SH AX N |
| FINANCIAL | F AY N AE N SH AX L |
| GROUP | G R UW PD |
| CAPITAL | K AE P IX T AX L |
| TRUST | T R AH S TD |

Short words (i.e., words having less than a predefined number of phonemes) are automatically combined by the short word combiner 135 to form combined words (step 260). The weights for the combined words are then automatically generated by the database update device 120 (although the combined words need not, and in the preferred embodiment are not, included in the database) (step 265). Moreover, all possible baseforms of the combined words are then automatically generated by the baseform generator 130 (step 270). The short words are combined by the short word combiner 135 to improve the performance of the speech recognition system. It is to be appreciated that short words are combined until the number of phonemes of a combined word is equal to or greater than the predefined number of phonemes. As an example, the predefined number of phonemes may be set to six phonemes. Thus, given the two leading words “AMERICAN” and “AAMES” in the baseform file above, the first word has eight phonemes which is regarded as not a short word. Accordingly, the first word will not be combined with the next (second) word. However, the second word has only three phonemes which is regarded as a short word. Accordingly, the second word is combined with the next (third) word as follows: AAMES_FINANCIAL.

An example of the baseform file which includes a combined word is as follows:

| | |
|---|---|
| AAMES | AA M Z |
| AAMES_FINANCIAL | AA M Z F AY N AE N SH AX L |
| AMERICAN | AX M EH R IX K AX N |
| ANNUITY | AX N Y UW IX T IY |
| CORP | K AO R P AXR EY SH AX N |
| FINANCIAL | F AY N AE N SH AX L |
| GROUP | G R UW PD |
| CAPITAL | K AE P IX T AX L |
| TRUST | T R AH S TD |

The final grammar file is then generated to include the combined words (step 280), by the grammar generator 125.

Thus, with respect to the two entries in the grammar file above, the portion of the final grammar file corresponding thereto is as follows:

+0.010129856039 AMERICAN ANNUITY GROUP CAPITAL TRUST: NYSE_AAGPRT

+0.270129494365 AAMES FINANCIAL CORP: NYSE_AAM

+0.270129494365 AAMES_FINANCIAL CORP: NYSE_AAM

Although the illustrative embodiments have been described herein with reference to the accompanying drawings, it is to be understood that the present system and method is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for automatically updating stock and mutual fund grammars in a speech recognition system, comprising the steps of:
automatically updating, on a pre-specified basis, a database having a plurality of entries, each entry respectively corresponding to a publicly traded stock or a publicly traded fund, and respectively comprising at least one name of the publicly traded stock or publicly traded fund, a weight for the at least one name, and baseforms of the at least one name; and
automatically updating a grammar file for names in the database, the grammar file including the names and weights for the names.

2. The method according to claim 1, wherein said updating step comprises the steps of:
automatically identifying, from web sites, stocks and funds that are no longer listed on a market; and
automatically removing from the database any of the plurality of entries corresponding to the identified stocks and funds.

3. The method according to claim 1, wherein said updating step comprises the steps of:
automatically identifying, from web sites, newly listed stocks and newly listed funds, if any; and
automatically creating an entry in the database for each of the newly listed stocks and the newly listed funds.

4. The method according to claim 3, wherein said creating step comprises the steps of:
determining the weights for the names of the newly listed stocks and the newly listed funds; and
generating the baseforms of the names of the newly listed stocks and the newly listed funds.

5. The method according to claim 1, wherein said updating step comprises the steps of:
identifying the transaction volumes of any stocks and funds for which an entry exists in the database;
quantizing the transaction volumes into a plurality of bands; and
assigning a corresponding weight to each of the plurality of bands.

6. The method according to claim 5, wherein a given corresponding weight assigned to a given band corresponds to each of the names of any of the stocks and funds in the given band.

7. The method according to claim 1, further comprising the steps of:
automatically combining short words in the database to form combined words, a short word being a stock name or a fund name that has less than a predefined number of phonemes;
automatically generating the baseforms for the combined words; and
updating the grammar file to include the combined words.

8. The method according to claim 1, wherein said step of updating the database comprises the step of automatically adapting the weights for the names in the database, based upon a transaction volume over a predetermined period of time.

9. The method according to claim 1, wherein said step of updating the database is performed on a pre-specified basis.

10. The method according to claim 9, wherein the pre-specified basis is daily.

11. The method according to claim 1, wherein each of the plurality of entries further comprises one of corresponding resolved stock names or corresponding resolved fund names, if any.

12. The method according to claim 1, wherein each of the plurality of entries further comprises corresponding stock nicknames or corresponding fund nicknames, if any.

13. A method for automatically updating stock and mutual fund grammars in a speech recognition system, comprising the steps of:
constructing a database having a plurality of entries, each entry respectively corresponding to a publicly traded stock or a publicly traded fund, and respectively comprising at least one name of the publicly traded stock or publicly traded fund, a weight for the at least one name, and baseforms of the at least one name;
generating a grammar file for names in the database, the grammar file including the names and weights for the names;
automatically updating the database on a pre-specified basis, including adding new entries for newly listed stocks and newly listed funds and removing any of the plurality of entries corresponding to newly unlisted stocks and newly unlisted funds; and
automatically updating the grammar file with respect to the newly listed stock names and the newly listed fund names.

14. The method according to claim 13, wherein said step of removing any of the plurality of entries corresponding to the newly unlisted stocks and the newly unlisted funds comprises the step of automatically identifying, from web sites, stocks and funds that are no longer listed on a market.

15. The method according to claim 13, wherein said step of adding the new entries for the newly listed stocks and the newly listed funds comprises the step of automatically identifying, from web sites, the newly listed stocks and newly listed funds, if any.

16. The method according to claim 13, wherein said step of updating the database comprises the steps of:
identifying the transaction volumes of any stocks and funds for which an entry exists in the database;
quantizing the transaction volumes into a plurality of bands; and
assigning a corresponding weight to each of the plurality of bands.

17. The method according to claim 13, further comprising the steps of:
automatically combining short words in the database to form combined words, a short word being a stock name or a fund name that has less than a predefined number of phonemes;
automatically generating the baseforms for the combined words; and
updating the grammar file to include the combined words.

18. The method according to claim 13, wherein said step of updating the database comprises the step of automatically adapting the weights for the names in the database, based upon a transaction volume over a predetermined period of time.

19. The method according to claim 13, wherein each of the plurality of entries further comprises one of corresponding resolved stock names or corresponding resolved fund names, if any.

20. The method according to claim 13, wherein each of the plurality of entries further comprises corresponding stock nicknames or corresponding fund nicknames, if any.

21. The method according to claim 13, wherein said step of updating the database comprises the step of automatically generating baseforms of the newly listed stock names and the newly listed fund names.

22. An apparatus for automatically updating stock and mutual fund grammars in a speech recognition system, comprising:
a database update device for automatically updating, on a pre-specified basis, a database having a plurality of entries, each entry respectively corresponding to a publicly traded stock or a publicly traded fund, and respectively comprising at least one name of the publicly traded stock or publicly traded fund, a weight for the at least one name, and baseforms of the at least one name; and
a grammar generator for automatically updating a grammar file for names in the database, the grammar file including the names and weights for the names.

23. The apparatus according to claim 22, further comprising a web extractor for automatically identifying, from web sites, stocks and funds that are no longer listed on a market, and wherein said database update device automatically removes from the database any of the plurality of entries corresponding to the identified stocks and funds.

24. The apparatus according to claim 22, further comprising a web extractor for automatically identifying, from web sites, newly listed stocks and newly listed funds, if any, and wherein said database update device automatically creates an entry in the database for each of the newly listed stocks and the newly listed funds.

25. The apparatus according to claim 24, wherein said database update device determines the weights for the names of the newly listed stocks and the newly listed funds, and said apparatus further comprises a baseform generator for generating the baseforms of the names of the newly listed stocks and the newly listed funds.

26. The apparatus according to claim 22, wherein said database update device identifies the transaction volumes of any stocks and funds for which an entry exists in the database, quantizes the transaction volumes into a plurality of bands, and assigns a corresponding weight to each of the plurality of bands.

27. The apparatus according to claim 26, wherein a given corresponding weight assigned to a given band corresponds to each of the names of any of the stocks and funds in the given band.

28. The apparatus according to claim 22, further comprising:
a short word combiner for automatically combining short words in the database to form combined words, a short word being a stock name or a fund name that has less than a predefined number of phonemes; and
a baseform generator for automatically generating the baseforms for the combined words; and
wherein said grammar generator updates the grammar file to include the combined words.

29. The apparatus according to claim 22, wherein said database update device automatically adapts the weights for the names in the database, based upon a transaction volume over a predetermined period of time.

30. The apparatus according to claim 22, wherein said database update device updates the database on a pre-specified basis.

31. The apparatus according to claim 30, wherein the pre-specified basis is daily.

32. The apparatus according to claim 22, wherein each of the plurality of entries further comprises one of corresponding resolved stock names or corresponding resolved fund names, if any.

33. The method according to claim 22, wherein each of the plurality of entries further comprises corresponding stock nicknames or corresponding fund nicknames, if any.
